(19) United States
(12) Patent Application Publication
(10) Pub. No.: US 2003/0132146 A1
(43) Pub. Date: Jul. 17, 2003

(54) Arrangement for filtering plastic melts

(76) Inventor: Detlef Gneuss, Bad Oeynhausen (DE)

Correspondence Address: Friedrich Kueffner, Suite 910, 317 Madison Avenue, New York, NY, 10017, US

(21) Appl. No.: 10/149,838

(22) PCT Filed: Dec. 12, 2000
(86) PCT No.: PCT/EP00/12598

(30) Foreign Application Priority Data
Dec. 17, 1999 (DE) 19961426.1

(51) Int. Cl. B01D 29/62

(52) U.S. Cl. 210/108; 210/411

(57) ABSTRACT

The invention relates to an arrangement for filtering plastic melts. Dirty filter elements (4, 4) can be liberated from collected dirt particles by means of backwashing. The melt (8) used for backwashing is deviated from the main melt flow and can optionally and additionally be impinged upon by conveying elements. Backwash is periodically initiated according to the time and/or the degree of soiling of the filter element to be cleaned. The aim of the invention is to improve the inventive arrangement in such a way that cleaning is optimal according to the degree of soiling of the filter element to be cleaned respectively. A control device (7) is provided which detects the melt volume and/or the flow rate of the backwashing melt during a backwashing procedure.

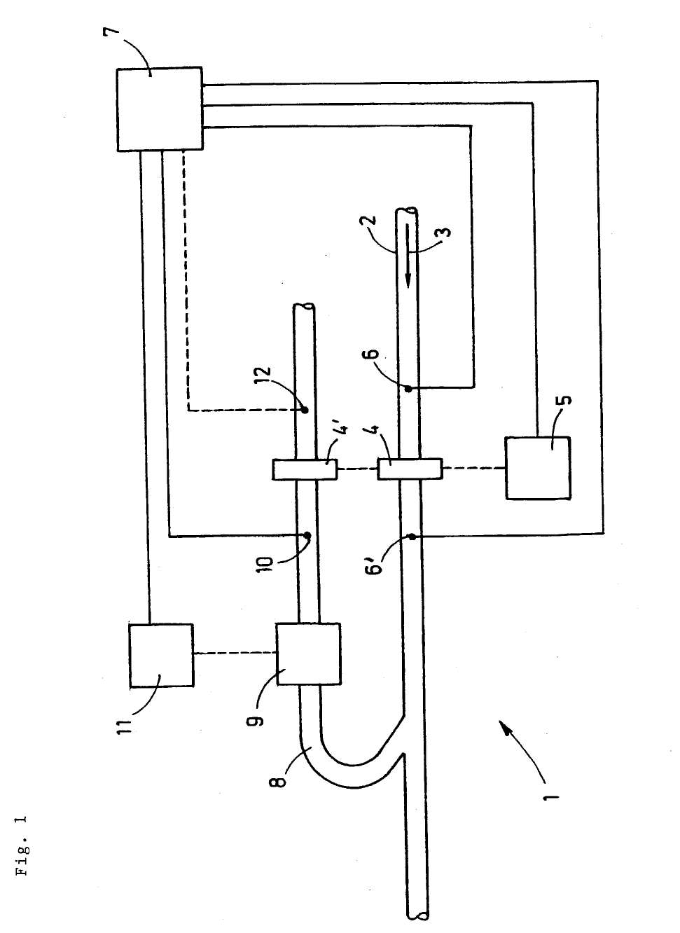

The invention pertains to an arrangement for filtering plastic melts, in which dirty filter elements can be freed of collected dirt particles by back-washing, where the melt used for back-washing is taken from the main melt stream and is possibly subjected to the additional action of transport elements, and where the back-washing process is initiated periodically, as a function of time, and/or as a function of the degree of contamination of the filter element to be cleaned.

These types of filter arrangements are known. They have a filter element in a channel through which the main melt stream passes. Periodically, as a function of time, or as a function of the degree of contamination, the filter element is moved out of the main melt stream and replaced by a new or cleaned filter. The used filter, which is usually dirty, is conveyed to a channel which branches off from the main melt stream channel, so that the filter element can be cleaned by back-washing. It is also possible for melt-transporting elements such as feed pumps or shot pistons to be installed in the bypass channel where the filter element is cleaned.

It has been found that neither the back-washing caused by the pressure of the main stream nor the back-washing achieved by means of a pump or a shot piston always produces the desired optimum results in terms of the cleaning of the used filter element.

The invention is therefore based on the task of improving an arrangement of the general type in question for filtering plastic melts in such a way that optimum cleaning is always carried out as a function of the degree of contamination of the filter element to be cleaned.

To accomplish this task, a control device is proposed, which determines the melt volume and/or the flow rate of the back-washing melt of the back-washing process. As a result, it is possible to supply preferably a specific quantity of melt at a specific flow rate to the filter element to be cleaned. On the basis of empirical values, the operator can adjust the quantity of melt and the flow rate as a function of the anticipated degree of contamination.

It is also possible, however, for certain process parameters to be determined and on that basis for the control device to be adjusted manually to the cleaning efficiency associated with a certain back-washing volume and/or flow rate. The process parameters which are determined give the operator information concerning the degree of contamination of the filter to be cleaned, so that the operator can then preferably adjust the required melt volume and the flow rate of the back-washing melt manually in such a way that the filter to be cleaned is optimally freed of dirt particles.

The process parameters can be determined by sensors installed in the back-washing circuit and/or in the channel of the main melt stream; these measurement values can be displayed, for example, on a screen. The sensors can be pressure sensors. The degree of contamination can be determined by comparing the nominal pressure associated with a new filter element with the actual pressure value.

It is also possible, however, to determine the degree of contamination of the filter element to be cleaned by determining the degree of contamination of the melt obtained downstream from the filter element to be cleaned after the completion of the back-washing.

If a closed-loop control device is used instead of an open-loop device, the process parameters determined by the sensors can be sent to the closed-loop control circuit, where the corresponding comparison between nominal and actual values is performed. Then the necessary settings are made automatically on the basis of a stored list of degrees of contamination and the melt volumes and/or flow rates assigned to them. In an appropriate automatic control device, the necessary melt volumes and/or flow rates can also be calculated by the use of a mathematical model on the basis of the determined degree of contamination.

The invention is explained in greater detail below on the basis of a description of a drawing.

The figure shows an arrangement 1 for filtering plastic melts. The main melt stream 3 is conducted through a channel 2. Only part of the channel 2 is shown. It can be connected at one end to an extruder (not shown) and at the other to an injection-molding machine. A filter element 4, which can be moved out of the channel 4 by a drive device 5, is installed in the channel 2.

The drive device 5 can move the filter element out of the channel 2 periodically or as a function of time. The figure, however, shows that an automatic control device 7 can use the measurement results transmitted to it from the sensors 6, 6′ to compare the pressures, for example, and thus to determine the degree of contamination of the filter 4. The drive device 5 is then turned on to replace the filter element 4 only after a certain degree of contamination has been reached. If desired, the automatic control device 7 can also determine the speed required to replace the filter element 4 and to send the appropriate command to the drive 5.

A back-washing circuit 8 branches off from the channel 2. In the back-washing circuit 8, a transport element 9 is installed, which is fed by the main melt stream 3 and which is able to provide the melt volume and/or flow rate of back-wash melt required to accomplish the desired back-washing. A filter element 4′ to be cleaned is also inserted in the back-washing circuit 8. A sensor 10 sends the actual pressure values in the back-washing circuit 8 to the automatic control device 7, which compares the actual with the nominal values and possibly refers to contamination values determined by the sensors 6, 6′ and a list of stored contamination values. It then transmits the appropriate actuating signal to the drive device 11 of the transport element 9. As part of this process, the automatic control device 7 can use the measured degree of contamination to call up an equivalent degree of contamination, stored in its memory, and the melt volumes and/or flow rates associated with it and transmit these called-up values as nominal values to the drive device 11. Because different melt volumes and/or flow rates of back-wash melt will be required for different degrees of contamination of the filter element 4′ and for different melt melt viscosities, and because the storing of a large number of equivalent degrees of contamination values may prove to be too expensive, the cleanliness of the filter element 4′ can also be determined optionally by means of a sensor 12. The measurement signal of the sensor 12 for determining the degree of contamination of the melt obtained after back-washing downstream from the filter element to be cleaned can be sent to the automatic control circuit 7 and used to determine the optimum values for actuating the drive device 11. As a result, the melt volume and/or flow rate of the back-washing melt can be adjusted to the optimum values as a function of the contamination of the filter element 4′ to be cleaned.

### LIST OF REFERENCE NUMBERS

1 filter arrangement

2 channel

3 main melt stream

4 filter element

5 drive device

6 sensor

7 automatic control device

8 back-washing circuit

9 transport element

10 sensor

11 drive device

12 sensor

1. Arrangement (1) for filtering plastic melts, in which contaminated filter elements (4′) can be freed of collected dirt particles by back-washing, where the melt used for back-washing is branched from the main melt stream (3) and possibly subjected to the additional action of transport elements (9), and where the back-washing is initiated periodically, as a function of time, and/or as a function of the degree of contamination of the filter element to be cleaned, characterized by an open-loop control device (7), which determines the melt volume and/or the flow rate of the back-washing melt used in a back-washing process.

2. Arrangement according to claim 1, characterized in that, on the basis of certain measured process parameters, the control device (7) can be set manually to the cleaning efficiency associated with a certain back-washing volume and/or flow rate.

3. Arrangement according to claim 2, characterized in that the back-washing circuit (8) is equipped with sensors (10), which determine the degree of contamination of the filter element (4′) and which serve to record the process parameters.

4. Arrangement according to claim 3, characterized in that the sensors (10) are designed as pressure sensors, which are installed in the back-washing circuit (8).

5. Arrangement according to one of claims 2-4, characterized in that the back-washing circuit (8) is equipped with sensors (12), which detect the degree of contamination of the melt downstream from the filter element (4′) to be cleaned after the completion of the back-washing process, which values are used to record the process parameters.

6. Arrangement according to claim 5, characterized in that the sensors (12) are designed as emitters and receivers of electromagnetic or acoustic waves.

7. Arrangement according to claim 6, characterized in that the sensors (12) are designed as optical sensors, especially as laser scanning sensors.

8. Arrangement according to claim 6 or claim 7, characterized in that the sensors (12) are designed as acoustic sensors, especially as ultrasound sensors.

9. Device according to one of claims 1-8, characterized in that the control device is designed as an automatic control device (7).
